(19) United States
(12) Patent Application Publication
(10) Pub. No.: US 2015/0316011 A1
(43) Pub. Date: Nov. 5, 2015

(54) SEALING BODY FOR ISOLATING VIBRATIONS FROM CYLINDER BODY TO NOZZLE

(71) Applicant: Electro-Motive Diesel, Inc., LaGrange, IL (US)

(72) Inventors: Nicholas Denman Norris, Chicago, IL (US); Stuart Bell, Chicago Heights, IL (US)

(73) Assignee: Electro-Motive Diesel, Inc., LaGrange, IL (US)

(21) Appl. No.: 14/269,608

(22) Filed: May 5, 2014

(51) Int. Cl. F02M 55/04; F16L 55/02; F02M 55/00; F16J 15/06

(52) U.S. Cl. CPC F02M 55/04; F16J 15/064; F16L 55/02; F02M 55/004

(57) ABSTRACT

A sealing body for isolating vibrations is provided. The sealing body isolates vibrations from a cylinder body to a nozzle received at a port of the cylinder body. The sealing body includes a first portion configured to abut the port of the cylinder body. The sealing body further includes an elongated mid-portion extending from the first portion. The mid-portion is configured to resiliently absorb vibrations from the cylinder body. The sealing body further includes a second portion. The second portion is disposed within the port and located rearward of the first portion. The second portion is configured to abut the nozzle.

### TECHNICAL FIELD

The present disclosure generally relates to a sealing system for a cylinder body of an engine. More particularly, the present disclosure relates to a sealing system for a cylinder body that also isolates vibrations from the cylinder body to a nozzle coupled thereto.

### BACKGROUND

An engine body may typically experience vibrations during operation. These vibrations may transfer into components that are located adjacent to or associated with the engine body. One such associated component may be a fuel nozzle that is configured to supply fuel to cylinders of the engine. In order to supply fuel with little or no leakage, spaces between the fuel nozzle and the engine body may need to be sealed so that the fuel may enter the cylinder of the engine.

Many types of injector systems have been developed in the past to supply fuel with little or no leakage. For reference, PCT Published Application WO 2012/157001 A1 (hereinafter '001 application) relates to an injector system that is characterized to allow alternative injection of gas oil and gas using only one injection system. However, the sprayer disclosed in the '001 application is in direct contact with the engine body thereby being susceptible or prone to vibrations from operation of the engine body.

Therefore, there is a need for a system and method that seals spaces between the engine body and the nozzle provided thereto. Moreover, there is also a need to isolate the vibrations from the engine body from entering the fuel nozzles.

### SUMMARY OF THE DISCLOSURE

In one aspect, the present disclosure discloses a sealing body for isolating vibrations. The sealing body isolates vibrations from a cylinder body to a nozzle received at a port of the cylinder body. The sealing body includes a first portion configured to abut the port of the cylinder body. The sealing body further includes an elongated mid-portion extending from the first portion. The mid-portion is configured to resiliently absorb vibrations from the cylinder body. The sealing body further includes a second portion. The second portion is disposed within the port and located rearward of the first portion. The second portion is configured to abut the nozzle.

In another aspect, the present disclosure discloses a method of isolating vibrations from a cylinder body to a nozzle received at a port of the cylinder body. The method includes disposing a first portion of a sealing body in contact with the port of the cylinder body. The method further includes providing an elongated mid-portion extending from the first portion; wherein the mid-portion is configured to resiliently absorb vibrations from the cylinder body. The method further includes providing a second portion of a sealing body within the port and rearward of the first portion, wherein the second portion is configured to abut the nozzle.

Other features and aspects of this disclosure will be apparent from the following description and the accompanying drawings.

### BRIEF DESCRIPTION OF THE DRAWINGS

FIG. 1 is an assembled view of an exemplary nozzle, an exemplary cylinder body, and a sealing body in accordance with an embodiment of the present disclosure;

FIG. 2 is an exploded view of the exemplary nozzle, the exemplary cylinder body, and the sealing body of FIG. 1;

FIG. 3 is a side sectional view of the exemplary nozzle, the exemplary cylinder body, and the sealing body of FIG. 1;

FIG. 4 is a perspective view of the sealing body in accordance with another embodiment of the present disclosure;

FIG. 5 is a side sectional view of the exemplary cylinder body, the nozzle in accordance with another embodiment of the present disclosure, and the sealing body of FIG. 4;

FIG. 6 is a perspective view of the sealing body in accordance with yet another embodiment of the present disclosure;

FIG. 7 is a sectional view of the sealing body taken along A-A′ of FIG. 6;

FIG. 8 is a perspective view of the sealing body in accordance with an alternative embodiment of the present disclosure;

FIG. 9 is a sectional view of the sealing body taken along B-B′ of FIG. 8; and

FIG. 10 is a method of isolating vibrations from the cylinder body to the nozzle received at a port of the cylinder body.

### DETAILED DESCRIPTION

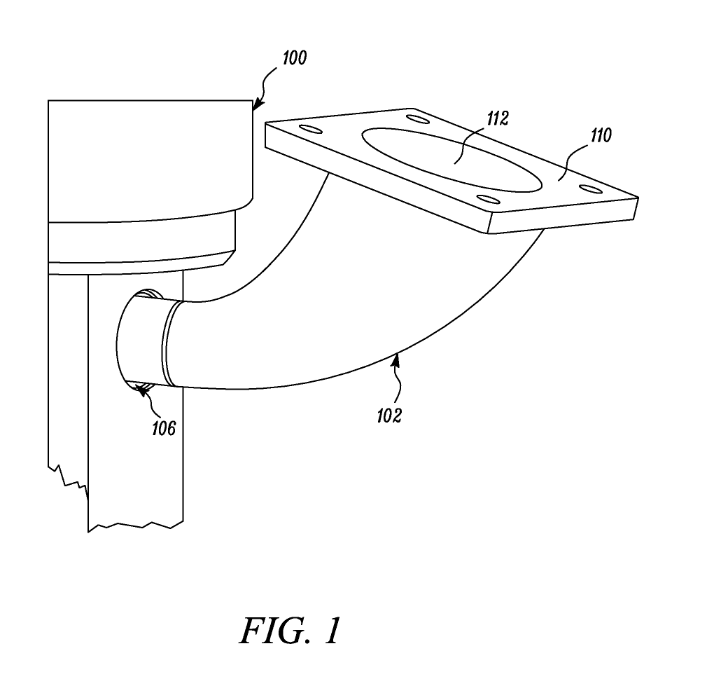

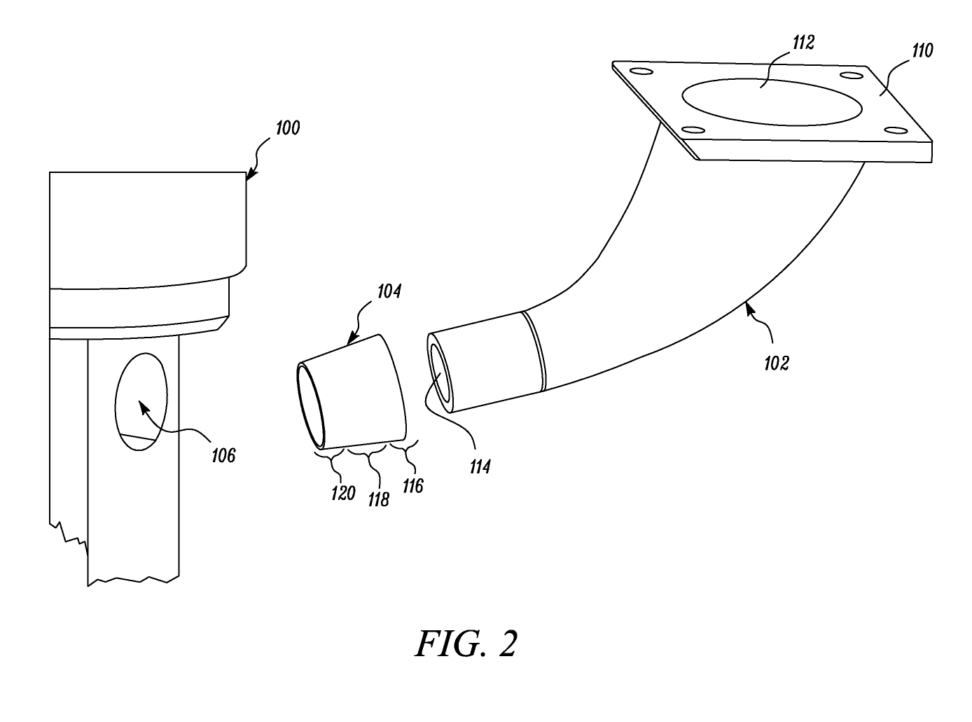

The present disclosure relates to a sealing body for isolating vibrations. FIGS. 1 and 2 illustrate an assembled view and an exploded view of a cylinder body 100, a nozzle 102, and a sealing body 104 in accordance with an embodiment of the present disclosure. The cylinder body 100 may form part of an engine (not shown) that is configured to operate by combustion of fuel. The fuel may be, for example, gasoline, diesel, natural gas, or even pre-mixed fuel. Moreover, the engine may be of a type such as, but not limited to, a rotary engine, a reciprocating engine, and a gas turbine engine.

Any reference to the types and configurations of the cylinder bodies and/or the engines herein is merely exemplary in nature. One of ordinary skill in the art will acknowledge that embodiments of the present disclosure can be applied to many other types and configurations of cylinder bodies and/or engines known in the art without deviating from the spirit of the present disclosure. Further, the cylinder body 100 may include associated system components such as, but not limited to, cylinder liners, sleeves, or other components typically known to one skilled in the art. However, such components have been deliberately omitted from the accompanying drawings to bring about clarity and aid the reader in understanding of the present disclosure.

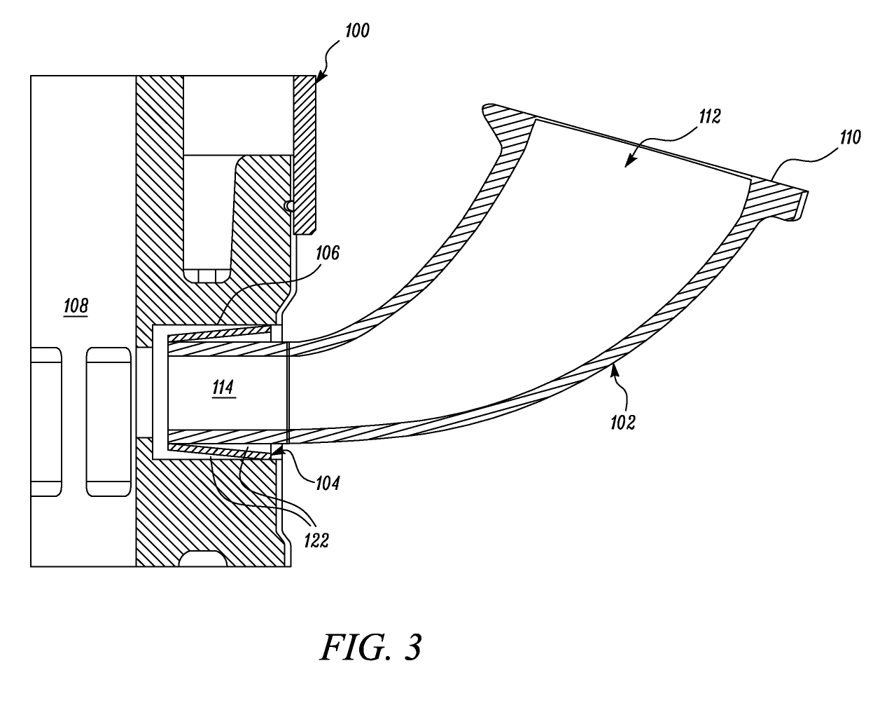

Referring to FIGS. 1, 2, and 3, the cylinder body 100 defines a port 106 extending therein. As best shown in FIG. 3, the port 106 is disposed in fluid communication with a combustion chamber 108 of the cylinder body 100.

Referring again to FIGS. 1, 2, and 3, the nozzle 102 includes a flange 110 that is releasably coupled with a fuel supply system (not shown). The nozzle 102 includes an inlet 112 to receive fuel from the fuel supply system. The nozzle 102 may then pressurize the received fuel and supply the pressurized fluid into the combustion chamber 108 via an outlet 114.

With reference to FIGS. 1, 2, and 3, it can be seen that the nozzle 102 is connected to the port 106 of the cylinder body 100 with the help of the sealing body 104. As best shown in FIG. 3, the sealing body 104 includes a first portion 116 that abuts the port 106 of the cylinder body 100. Additionally, the sealing body 104 also includes an elongated mid-portion 118, and a second portion 120. The mid-portion 118 extends from the first portion 116 and is disposed within the port 106. The second portion 120 is also disposed within the port 106, and is located rearward of the first portion 116 (when viewing from R.H.S of FIG. 3). Moreover, the second portion 120 is disposed in abutment with the nozzle 102.

As depicted in the illustrated embodiments, the sealing body 104 is shaped in the form of a hollow frustum. The sealing body 104 is configured to seal an annular cavity 122 present between the port 106 and the nozzle 102. The first portion 116 and the second portion 120 of the sealing body 104 are configured to restrict a movement of fluid, in this case fuel and/or air, from the port 106 and the nozzle 102 to an exterior of the cylinder body 100. One of ordinary skill in the art will therefore appreciate that the sealing body 104 may beneficially prevent the fuel and/or the air from leaking out into the atmosphere.

Further, one of ordinary skill in the art will acknowledge that as with conventional engines, the engine of the present disclosure may similarly vibrate during operation. Since the cylinder body 100 forms part of the engine, these vibrations may also be experienced by the cylinder body 100. It is beneficially contemplated herein that the mid-portion 118 of the sealing body 104 can be configured to resiliently absorb vibrations from the cylinder body 100.

In one embodiment, the sealing body 104 may be made up of a metal. In another embodiment, the sealing body 104 may be made up of an alloy. For example, the sealing body 104 may be made from spring steel, or other Nickel based steel alloys as commonly known to a person skilled in the art. However, in alternative embodiments, the sealing body 104 can also be made from polymers, composite materials, or any combinations thereof.

Also, in various embodiments of the present disclosure, a natural frequency of the sealing body 104 is substantially similar to a natural frequency of the cylinder body 100. However, the natural frequency of the sealing body 104 is kept different from that of the nozzle 102. In this way, the sealing body 104 can effectively dampen vibrations to a minimum, and prevent the nozzle 102 from experiencing the vibrations.

A person having ordinary skill in the art will acknowledge that the natural frequency of the sealing body 104 depends on factors such as, but not limited to, size, shape, and material with which the sealing body 104 is made. Additionally, the natural frequency of the sealing body 104 may also be influenced by a cross-sectional profile, a longitudinal profile, and the overall form to which it is manufactured. Therefore, depending on specific requirements of an application, specific materials may be selected to forming the sealing body 104 of the present disclosure.

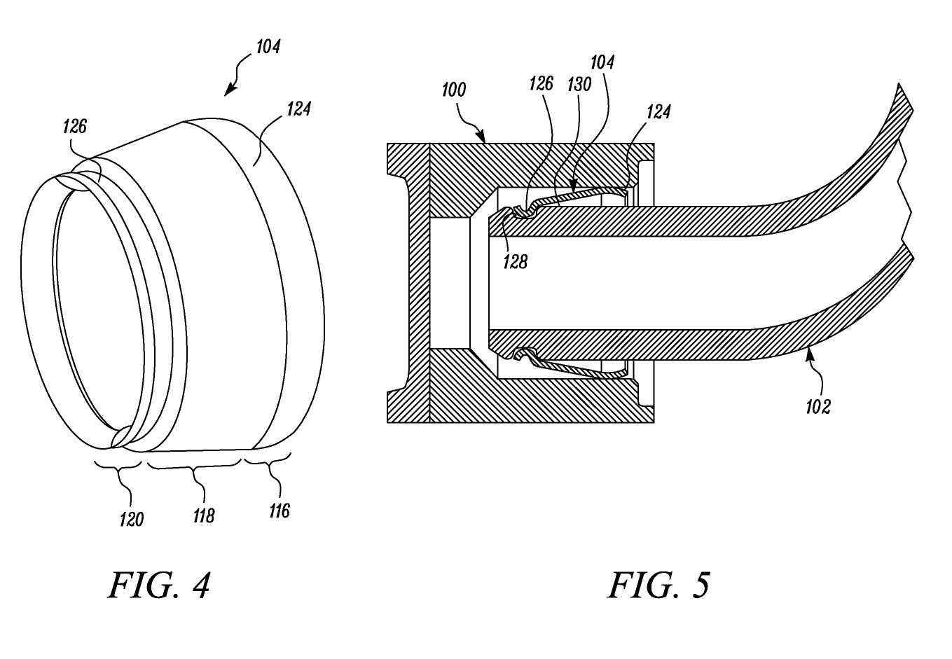

Although some exemplary shapes and/or profiles of the sealing body 104 will be explained hereinafter in conjunction with FIGS. 4 to 9, it should be noted that the disclosed shapes and/or profiles are non-limiting of this disclosure. Various modifications/deletions/additions can be contemplated and made to the shapes and/or profiles of the sealing body 104 disclosed herein without deviating from the spirit of the present disclosure.

FIG. 4 illustrates the sealing body 104 in accordance with another embodiment of the present disclosure. As shown, the first portion 116 and the second portion 120 of the sealing body 104 define a pair of involute lips 124, 126 therein. Referring to FIG. 5, these lips 124, 126 are configured to abut the port 106 and the nozzle 102 respectively. Moreover, it can be seen that the lips 124 and 126 are involute to varying degrees. In the illustrated embodiments of FIGS. 4 and 5, the lip 126 is shown folded to a larger extent than lip 124. Accordingly, as shown, an annular groove 128 may be additionally defined on an outer surface 130 of the nozzle 102, so that the involute lip 126 can seat into the annular groove 128 of the nozzle 102.

Additionally, if the involute lip 124 is also folded to an adequate extent, then a corresponding annular groove can optionally be provided in the port 106 of the cylinder body 100. This way, the involute lip 124 also may seat into the defined annular groove. Therefore, it is evident to one of ordinary skill in the art that other configurations of positionally locking the sealing body 104 between the nozzle 102 and the port 106 can be advantageously contemplated without deviating from the spirit of the present disclosure.

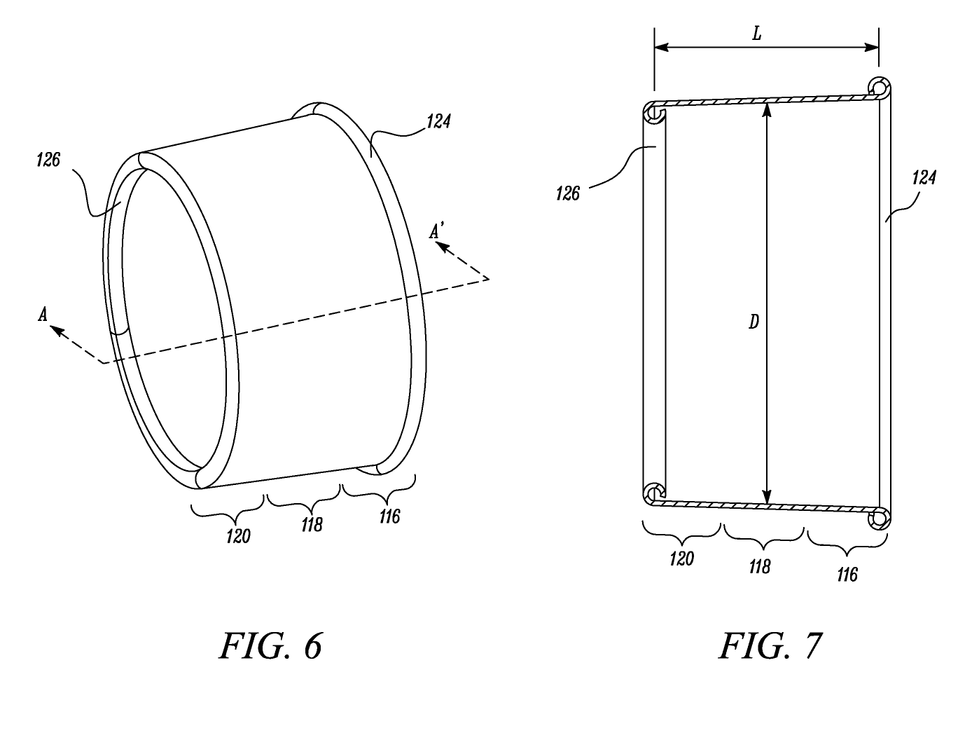

Referring to FIGS. 6 and 7, yet another embodiment of the sealing body 104 is shown. In this embodiment, the sealing body 104 is formed with a substantially straight cross-section through all or most of its length L as compared to the hollow frustum depicted in the embodiments of FIGS. 1, 2, and 3. Therefore, the sealing body 104 may exhibit a uniform diameter D throughout its length L.

Moreover, the involute lips 124, 126 defined at the first and second portions 116, 120 are folded to a substantially larger extent than the involute lips 124, 126 depicted in the embodiments of FIGS. 4 and 5. Also, as shown in FIGS. 6 and 7, an extent of folding accomplished in the involute lips 124, 126 is similar or equal to each other.

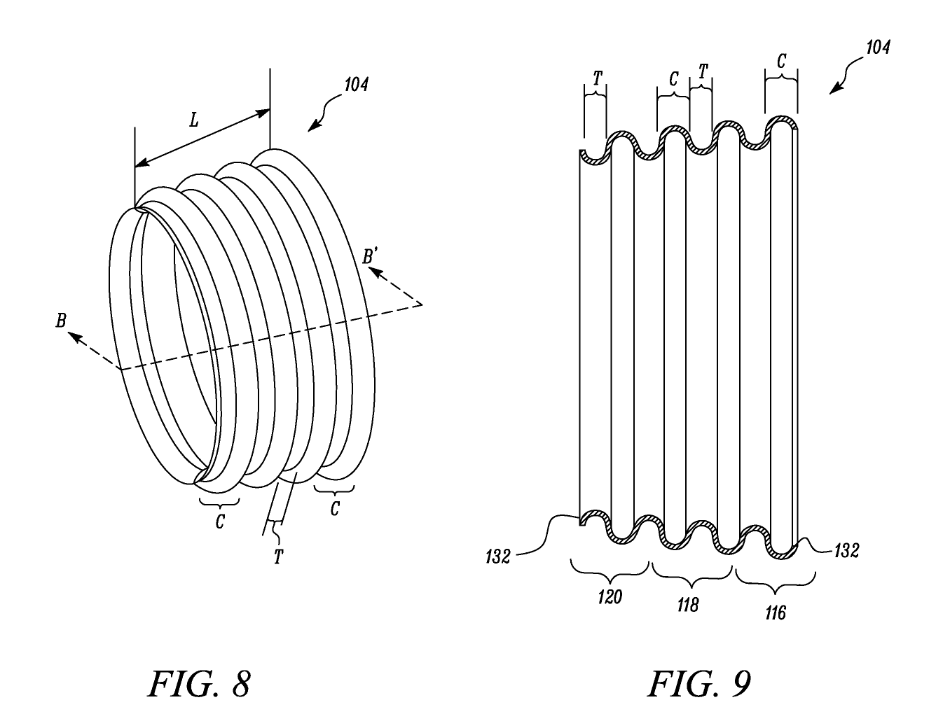

Referring to FIGS. 8 and 9, an alternative embodiment of the sealing body 104 is shown. In this embodiment, the sealing body 104 has a corrugated and a frustoconical profile. The sealing body 104 includes crest sections C and trough sections T that are alternately disposed along the length L of the sealing body 104. In this embodiment, the crest section C and the trough section T that are located at ends 132 of the sealing body 104 may be disposed in abutment with the port 106 and the nozzle 102 respectively.

However, if a straight profile is used in place of the frustoconical profile in the embodiment of FIGS. 8 and 9, it may be possible to abut more than one crest section C with the port 106 of the cylinder body 100, and at least one trough section T with the nozzle 102. It is envisioned that by implementing the straight profile on the sealing body 104 and executing the preceding manner of abutment, the sealing body 104 may dampen vibrations more severely and therefore, significantly minimize the vibrations experienced by the nozzle 102.

Although the embodiments of FIGS. 4 to 9 are disclosed herein, it is to be noted that such disclosed embodiments are only to be taken in the illustrative and/or explanatory sense. One of ordinary skill in the art will acknowledge that depending on frequency and/or amplitude of the vibrations, besides other specific requirements of an application, numerous other configurations, profiles, and/or shapes can be advantageously implemented for the sealing body 104 without deviating from the scope of the appended claims.

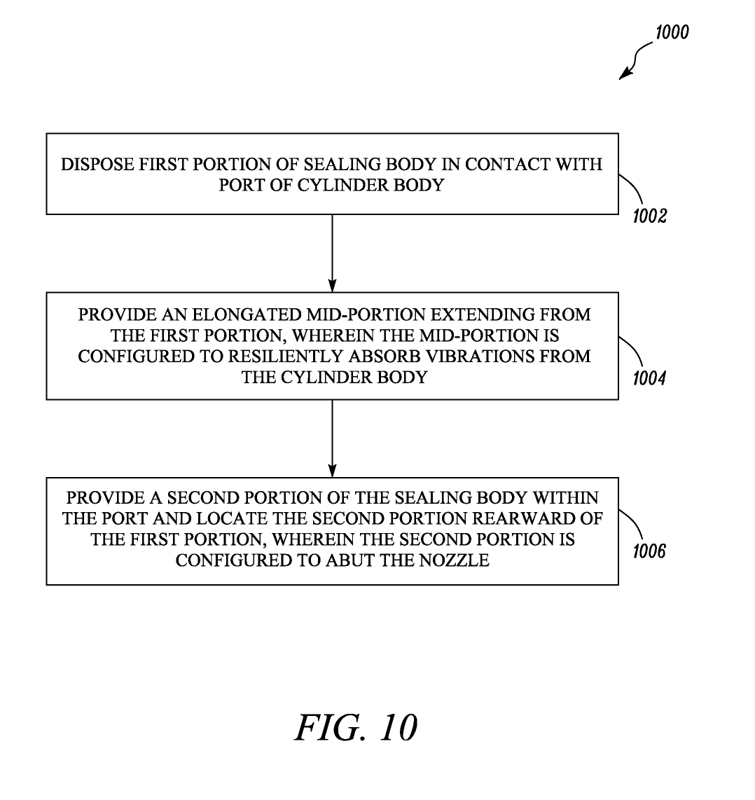

FIG. 10 illustrates a method 1000 of isolating vibrations from the cylinder body 100 to the nozzle 102. At step 1002, the method 1000 includes disposing the first portion 116 of the sealing body 104 in contact with the port 106 of the cylinder body 100. At step 1004, the method 1000 further includes providing the elongated mid-portion 118, wherein the elongated mid-portion 118 extends from the first portion 116. The mid-portion 118 is configured to resiliently absorb vibrations from the cylinder body 100. At step 1006, the method 1000 further includes providing the second portion 120 within the port 106 and locating the second portion 120 rearward of the first portion 116, wherein the second portion 120 is configured to abut the nozzle 102.

Various embodiments disclosed herein are to be taken in the illustrative and explanatory sense, and should in no way be construed as limiting of the present disclosure. All directional references (e.g., inward, outward, radial, upper, lower, upward, downward, left, right, leftward, rightward, L.H.S, R.H.S, top, bottom, above, below, vertical, horizontal, clockwise, and counter-clockwise) are only used for identification purposes to aid the reader's understanding of the present disclosure, and may not create limitations, particularly as to the position, orientation, or use of the devices and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

In methodologies directly or indirectly set forth herein, various steps and operations are described in one possible order of operation, but those skilled in the art will recognize that steps and operations may be rearranged, replaced, or eliminated without departing from the spirit and scope of the present disclosure as set forth in the claims.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure has applicability in sealing of annular spaces or cavities between a cylinder body and a nozzle while also executing the damping of vibrations. One of ordinary skill in the art will acknowledge that the present disclosure can be applied in various industrial settings such as, but not limited to, HVAC, power systems, engine manufacturing, hydraulics, pneumatics, and other applications where sealing and damping functions are required.

As vibrations are known to be detrimental to a component's life, the sealing body 104 of the present disclosure can be beneficially used to dampen such vibrations and prolong a service life of the components. Therefore, use of the sealing body 104 can help manufacturers of engines, cylinder bodies, and/or nozzles to provide a simple and cost-effective solution for sealing of annular spaces or cavities and also for damping of vibrations. Additionally, due to the various possibilities in design of the sealing body 104, manufacturers are offered with versatility to form the sealing body 104 and satisfy specific requirements associated with sealing and damping in a given application.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A sealing body for isolating vibrations from a cylinder body to a nozzle received at a port of the cylinder body, the sealing body comprising:
a first portion configured to abut the port of the cylinder body;
an elongated mid-portion extending from the first portion, wherein the mid-portion is configured to resiliently absorb vibrations from the cylinder body; and
a second portion disposed within the port and located rearward of the first portion, the second portion configured to abut the nozzle.

2. The sealing body of claim 1, wherein the sealing body is configured to seal an annular cavity present between the port and the nozzle.

3. The sealing body of claim 2, wherein the first and second portions of the sealing body are configured to restrict movement of fluid from the port and the nozzle to an exterior of the cylinder body.

4. The sealing body of claim 1, wherein the sealing body is shaped in the form of a hollow frustum.

5. The sealing body of claim 4, wherein the first portion and the second portion define a pair of involute lips that are configured to abut the port and the nozzle respectively.

6. The sealing body of claim 1, wherein a profile of the sealing body is at least one of tiered, corrugated, fluted, and convoluted.

7. The sealing body of claim 1, wherein a natural frequency of the sealing body is substantially similar to a natural frequency of the cylinder body.

8. The sealing body of claim 7, wherein the natural frequency of the sealing body is different from a natural frequency of the nozzle.

9. The sealing body of claim 1, wherein the sealing body is made from one of a metal, a polymer, a composite, or any combinations thereof.

10. A method of isolating vibrations from a cylinder body to a nozzle received at a port of the cylinder body, the method comprising:
disposing a first portion of a sealing body in contact with the port of the cylinder body;
providing an elongated mid-portion extending from the first portion, wherein the mid-portion is configured to resiliently absorb vibrations from the cylinder body; and
providing a second portion of a sealing body within the port and rearward of the first portion, the second portion configured to abut the nozzle.

11. The method of claim 10, wherein the method includes sealing an annular cavity present between the port and the nozzle.

12. The method of claim 11, wherein the method includes restricting movement of fluid from the port and the nozzle to an exterior of the cylinder body.

13. The method of claim 10, wherein the sealing body is a hollow frustum.

14. The method of claim 10, wherein the first portion and the second portion define a pair of involute lips that are configured to abut the port and the nozzle respectively.

15. The method of claim 10, wherein a profile of the sealing body is at least one of tiered, corrugated, fluted, and convoluted.

16. The method of claim 10, wherein a natural frequency of the sealing body is substantially similar to a natural frequency of the cylinder body.

17. The method of claim 16, wherein the natural frequency of the sealing body is different from a natural frequency of the nozzle.

18. The method of claim 10, wherein the sealing body is made from one of a metal, a polymer, a composite, or any combinations thereof.
